(19) United States
(12) Patent Application Publication
(10) Pub. No.: US 2015/0044642 A1
(43) Pub. Date: Feb. 12, 2015

(54) Methods and Systems for Learning Computer Programming

(71) Applicant: Khan Academy, Mountain View, CA (US)

(72) Inventor: John Resig, Brooklyn, NY (US)

(21) Appl. No.: 14/454,678

(22) Filed: Aug. 7, 2014

Related U.S. Application Data
(60) Provisional application No. 61/864,791, filed on Aug. 12, 2013.

(51) Int. Cl. G06F 9/44; G09B 19/00; G06F 3/0484

(52) U.S. Cl. CPC G06F 8/34; G06F 3/0484; G09B 19/0053
USPC 434/118; 717/113

(57) ABSTRACT

A computer-implemented method for providing output(s) of machine readable instructions comprises providing software comprising one or more lines of machine-readable instructions. The one or more lines are associated with an output upon execution by a computer processor, and the output comprises at least one visual and/or audible component. Next, the software is executed using a computer processor to generate the output. The one or more lines of machine-readable instructions and the output are then displayed on an electronic display of the user. In some cases, the one or more lines of machine-readable instructions and the output are displayed on a web-based user interface on the electronic display. Based on one or more edits received from the user, the one or more lines of machine-readable instructions and the output are then updated. In some cases, the machine-readable instructions are updated without re-executing the software.

### CROSS-REFERENCE

This application claims priority to U.S. Provisional Patent Application Ser. No. 61/864,791, filed Aug. 12, 2013, which is entirely incorporated herein by reference.

### BACKGROUND

Learning to write computer programs can be an intimidating task. In order to write a program, a user may need to be aware of the commands that are available in the programming language.

Frustration for the novice programmer may arise when a program fails due to syntax errors, such as the use of a comma in a program statement when a semicolon is required. Logic, language, and syntax errors may appear in programs written by beginners. Debugging even a relatively simple program may take a novice programmer considerable amount of time.

Programmers routinely code using editors that may involve the use of programming commands and concepts, syntax and debugging errors. Such editors are not readily accessible to novice programmers, who may not have a developed understanding of the commands, concepts and syntax.

### SUMMARY

Methods for teaching a student to program software may involve the use of a computer code text editor and instructions to teach the student computer programming commands, concepts and syntax. Such methods, however, have various limitations, such as the inability to see a given output in real time as the software is executed by a computer processor or other logic.

The present disclosure provides systems and methods for teaching computer programming to a user (e.g., student). Methods of the present disclosure can be employed to teach a student programming commands, concepts and syntax in a manner that is readily understandable by, and intuitive to, the student. This can advantageously aid in overcoming at least some of the issues with conventional approaches for learning computer programming.

An aspect of the present disclosure provides a computer-implemented method for providing output(s) of machine readable instructions, comprising providing software comprising one or more lines of machine-readable instructions, wherein the one or more lines are associated with an output upon execution by a computer processor, wherein the output comprises at least one visual and/or audible component. Next, the software can be executed using the computer processor to generate the output. The one or more lines of machine-readable instructions and the output can be displayed on an electronic display of a user. In some cases, the one or more lines of machine-readable instructions and the output are simultaneously displayed on the electronic display. Next, one or more edits to the one or more lines of machine-readable instructions are received from the user. The one or more lines of machine-readable instructions and the output can then be updated based on the one or more edits. In some situations, the output is updated without re-executing the software.

The software can be provided in a memory location coupled to the computer processor. In some cases, the output is stored in a memory location in a rendered state.

The one or more edits can include an addition or deletion from the one or more lines of machine-readable instructions. In some situations, the electronic display further comprises a user interface, and the one or more lines of machine-readable instructions and the output are displayed in the user interface. The user interface can be a web-based user interface or a graphical user interface.

The electronic display and the computer processor can be part of an electronic device of the user. As an alternative, the computer processor can be part of a computer server that is remotely located with respect to the electronic device of the user (e.g., located at least 1 mile or 100 miles away from the electronic device of the user).

In some cases, the software comprises a plurality of lines of machine-readable instructions and the output corresponds to at least a subset of the plurality of lines. In such a case, the individual lines of the plurality of lines and a corresponding output on the electronic display can be sequentially displayed on the electronic display.

Another aspect of the present disclosure provides a computer-implemented method for providing computer programming instructions, comprising providing, on an electronic device of a user, a tutorial including (i) software having one or more lines of machine-readable code, (ii) an output associated with the machine-readable code, and (iii) instructional material associated with at least a subset of the one or more lines of machine-readable code. Next, one or more edits to the one or more lines of machine-readable code are received from the user on the electronic device. The one or more lines of machine-readable code and the output are then updated based on the one or more edits.

In some cases, the instructional material is provided on the electronic device as the one or more lines of machine-readable code are sequentially provided to the user. In some situations, providing the tutorial comprises executing the software by a computer processor to generate the output. The output can be updated without re-executing the software.

In some cases, providing the tutorial comprises providing the one or more lines of machine-readable code, the output and the instructional material on a user interface of the electronic device. The user interface can be a web-based user interface (e.g., a web browser) or a graphical user interface.

Another aspect of the present disclosure provides a compute readable medium comprising machine-executable code that, upon execution by one or more computer processors, implements any of the methods above or elsewhere herein.

Another aspect of the present disclosure provides a computer system comprising one or more computer processors and a memory location coupled thereto. The memory location can include machine-executable code that, upon execution by the one or more computer processors, implements any of the methods above or elsewhere herein.

Another aspect of the present disclosure provides a computer system for providing output(s) of machine readable instructions, comprising an electronic display comprising a user interface having at least a first panel and a second panel adjacent to the first panel, wherein the first panel displays software comprising one or more lines of machine-readable instructions and the second panel displays an output associated with the one or more lines of machine-readable instructions. The system further comprises a computer processor coupled to the electronic display and programmed to (i) execute the software comprising the one or more lines of machine-readable instructions to generate the output, (ii) simultaneously display the one or more lines of machine-readable instructions in the first panel and the output in the second panel, (iii) receive one or more edits to the one or more lines of machine-readable instructions from a user, and (iv) update the one or more lines of machine-readable instructions in the first panel and the output in the second panel based on the one or more edits. The output can be updated without re-executing the software.

The system can further include a memory location that (i) has the software and/or (ii) stores the output in a rendered state. The memory location can be coupled to the computer processor.

The software can include a plurality of lines of machine-readable instructions and the output can correspond to at least a subset of the plurality of lines. The computer processor can be programmed to sequentially display individual lines of the plurality of lines in the first panel and a corresponding output in the second panel.

The user interface can provide the user with a tutorial comprising the software, the output and instructional material associated with at least a subset of said one or more lines of machine-readable code. The tutorial can be displayed in a third panel of the user interface. The third panel can be adjacent to the first and/or the second panel.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF DRAWINGS

The novel features of the claimed invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “FIG.” or “FIGS.” herein) of which:

FIG. 1 shows a computer-implemented method for providing output(s) of machine readable instructions;

FIG. 2 shows a user interface comprising a code editor (left panel) and output field (right panel);

FIG. 3 shows a user interface that includes a menu field (left panel) with menu items corresponding to categories of saved code, and graphical elements (right panel) corresponding to saved code;

FIG. 4 shows a method for providing computer programming instructions;

FIG. 5 is a screenshot of a user interface of an example tutorial;

FIG. 6 schematically illustrates a system for facilitating methods of the disclosure;

FIG. 7 is a screenshot of a user interface for generating a new program;

FIG. 8 shows examples of functions that may be used in a code editor to generate a program with a given output;

FIGS. 9A and 9B are screenshots of an example program output (right panels) that is dynamically generated based on changes to code (left panels);

FIGS. 10A-10C are screenshots of an example output (right panels) that is dynamically updated with changes in computer code (left panels);

FIG. 11 is a screenshot of a user interface showing community programs created by various users; and

FIG. 12 is a screenshot of a user interface showing an example Mandelbrot Set program.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The term “computer code” or “code,” as used herein, generally refers to one or more instructions that are readable (e.g., executable) by a computer processor or other computer logic to effect one or more operations. In some cases, computer code can yield one or more outputs, such as a visual and/or audible output. An output can be static (e.g., not changing with time) or dynamic (e.g., changing with time). An example of an output is a stationary ellipse. Another example of an output is an ellipse that translated within an output window.

Code can generate an output when it is executed by a computer processor (or other logic). In some cases, code can be re-executed to effect the output or one or more other outputs. Upon execution, the runtime state of the code can be initialized. In some examples, upon re-execution of the code, the code is completely re-run (i.e., from start to finish) and the runtime state is re-initialized.

Methods for Displaying Computer Code with Associated Output

An aspect of the present disclosure provides methods for computer-assisted computer programming. Such methods can be used to enable computer programmers of various levels (beginner to expert) to experience an output associated with computer code in a real time or substantially real time. This can enable students of computer programming to readily identify and associate code with a given output, which can advantageously provide for improved learning of computer programming. By being able to readily associate computer code and changes to the computer code with output(s), users (e.g., students) of methods and systems provided herein can get an improved computer programming learning experience.

Methods provided herein enable a user to immediately visualize the result(s) of computer code, which can advantageously enable the user to associate a given line or a plurality of lines of code with one or more outputs. For example, the user can visualize the result of changing a given function or a parameter. This provides a programming environment with code that may not be re-executed as the user makes changes, but those changes can be dynamically injected into the output without having to re-execute the code. This can enable the user to change variables and/or other elements of the code and see or otherwise experience (e.g., hear) the effects of those changes without the program restarting, which can provide for an effective learning environment for the user.

In some embodiments, code is not re-executed when a user makes changes to the code. This advantageously enables the user to make changes to the code and instantly or substantially instantly visualize the output or changes to the output that result(s) from the change(s). In some cases, however, there may be some examination or execution of the code being edited, but the entire code is not rerun every time a user changes the code, and the runtime state is not re-initialized when incorporating the user's latest changes. The code can be partially executed (i.e., behind the scenes) in order to detect which changes need to be injected into the runtime that is generating the output.

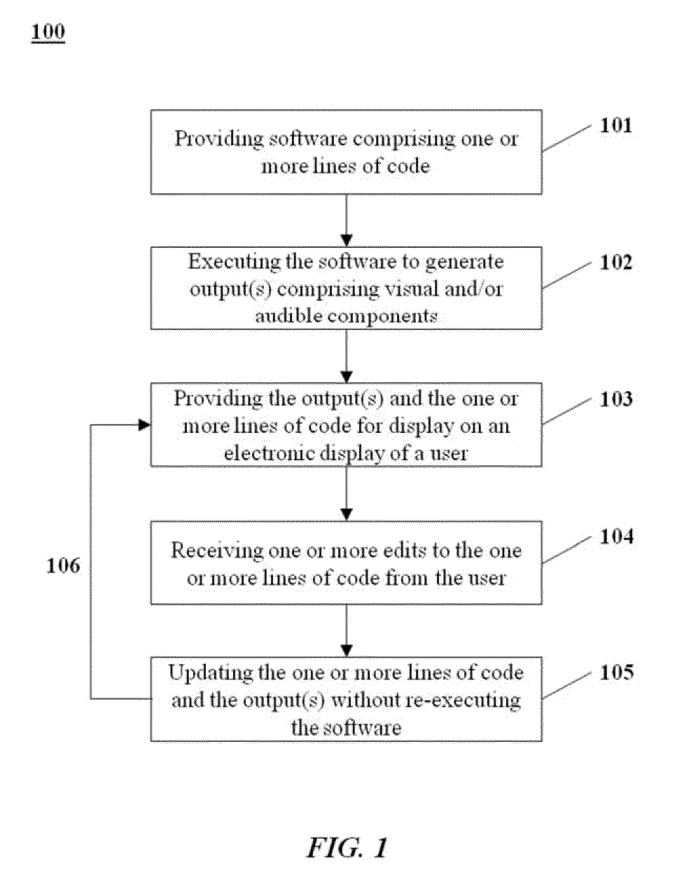

FIG. 1 shows a computer-implemented method 100 for providing output(s) of machine readable instructions. In a first operation 101, the method 100 comprises providing computer software (“software”) comprising one or more lines of machine-readable instructions (or code). The software can be provided by a computer system, such as a server, comprising a computer processor and memory for executing the software, as described elsewhere herein. The one or more lines can be associated with an output upon execution by a computer processor. The output can include at least one visual and/or audible component. For instance, the output can include one or more of text, geometric objects(s), and audible component(s).

Next, in a second operation 102, the software can be executed by a computer processor of the system to generate the output. The output can then be prepared to be presented to a user (e.g., student), such as on an electronic display of the user, or stored in a memory location to be presented to the user at a later point in time. If the output includes audible components, the output can be presented to the user via one or more speakers.

Next, in a third operation 103, the one or more lines of code and the output can be presented to the user, such as on an electronic display of the user. In some cases, the one or more lines of code and the output are displayed synchronously—for example, the output and the one or lines of code are displayed at the same time. As an alternative, the one or more lines of code and the output are displayed asynchronously—for example, the output is displayed after the one or more lines of code are displayed, such as at least about 0.1 seconds, 0.2 seconds, 0.3 seconds, 0.4 seconds, 0.5 seconds, or 1 second after. The electronic display can include a user interface (UI), such as a graphical user interface (GUI) or a web-based user interface (e.g., web browser), and the one or more lines of code and the output can be displayed on the UI. The electronic display can be part of an electronic device of the user, such as, for example, a personal computer (e.g., portable PC), slate or tablet PC (e.g., Apple® iPad, Samsung® Galaxy Tab), Smart phone (e.g., Apple® iPhone, Android-enabled device, Blackberry®), or personal digital assistant.

In some cases, the user may wish to make one or more edits to the software. Edits can include, without limitation, the deletion of computer code, addition of computer code or revision of computer code. In some examples, an edit includes the deletion of one or more lines of computer code, the addition of one or more lines of computer code, and/or the alteration of one or more lines of computer code. For example, the user may wish to change a parameter (e.g., object size) of the code to visualize the change in the output.

If the user wishes to edit the code, then in a fourth operation 104, the system receives form the user one or more edits to the one or more lines of code. Next, in a fifth operation 105, the one or more lines of code and the output can then be updated to reflect the edits. In some situations, the output is updated without re-executing the software. This can enable the user to see effect on the output upon changing the one or more lines of code in real time or substantially real time.

Next, in a sixth operation 106, with the updates, the one or more lines of code and the output can be presented to the user, such as on an electronic display of the user. Operations 103-106 can be repeated for any subsequent edits by the user.

In an example, a line of code has a function for outputting an ellipse on an electronic display of the user. The user edits the line of code by changing the dimensions of the ellipse. On the electronic display, the system presents the ellipse with the changed dimensions without re-executing the other lines of code. That is, the computer processor of the system does not execute all of the lines of code to present the updated ellipse.

The one or more lines of computer code (also “machine-readable code” and “machine-readable instructions” herein) can include multiple lines of computer code. At least a subset of the lines of computer code can be associated with a given output, such as a visual and/or audible component. The output can vary with time. For instance, the output can be an animation. The one or more lines of code can characterize one or more visual and/or audible elements of the output. Visual elements can be selected from the group consisting of object position, object orientation, object size, object shape, object color, object hue, object saturation, background color, background hue and background saturation.

In some embodiments, a computer-implemented method for providing output(s) of machine readable instructions comprise providing software comprising a plurality of lines of machine-readable instructions, and executing the software using a computer processor to generate a set of outputs comprising an output for each of the plurality of lines. A given line among the plurality of lines is associated with a given visual and/or audible output upon execution by the computer processor. The set of outputs can be stored in a memory location. Next, individual lines among the plurality of lines of machine-readable instructions can be displayed on an electronic device, such as, for example, an electronic display of the electronic device. An individual output from the set of outputs corresponding to the individual lines can be provided on the electronic device.

In some situations, individual lines of the plurality of lines of machine-readable instructions are sequentially displayed on a user interface, such as a graphical user interface or web-based user interface. The individual output can be displayed from the set of outputs without the computer processor re-executing the individual line.

The output can be displayed on the user interface together with the plurality lines of machine-readable instructions sequentially. In an example, a first line of the plurality of lines is displayed on the user interface and an output associated with the first line is also displayed on the user interface. Next, a second line of the plurality of lines is displayed on the user interface. If the second line affects any changes to the output that would result in a new output, the new output is also displayed in the user interface. This can be continued until the plurality of lines and its associated output(s) are displayed on the user interface.

The individual line and the individual output can be displayed simultaneously or substantially simultaneously. For example, the line and the output can be displayed within about 5 seconds, 4 seconds, 3 seconds, 2 seconds, 1 second, 0.5 seconds, 0.1 seconds, 0.01 seconds, 0.001 seconds, 0.0001 seconds, 0.00001 seconds, 0.000001 seconds, or less of one another. As an alternative, the individual line and the individual output can be display sequentially. For example, the line and the output can be displayed at least about 0.000001 seconds, 0.00001 seconds, 0.0001 seconds, 0.001 seconds, 0.01 seconds, 0.1 seconds, 1 second, 2 seconds, 3 seconds, 4 seconds, 5 seconds or more of one another.

A user can edit an individual line or multiple lines. An edit can include, without limitation, the deletion, addition, or alternation of a line. The individual output can be updated to reflect one or more edits from the user. In some situations, the individual output can be updated without the computer processor re-executing.

In an example, a line of code is associated with the size, orientation, alignment, position and color of a geometric object, such as a circle, triangle, square, rectangle, pentagon, hexagon, heptagon, octagon, or nonagon, or partial shapes or combinations thereof. The line of code can dictate the size, position and color of the geometric object. A line of code can be associated with computer logic, such as an algorithm or a function call. Multiple lines of code can be associated with an algorithm (e.g., FOR loop, IF-ELSE statement, WHILE loop).

An output or a set of outputs can be stored in a memory location of the system in a rendered state. For example, the system can execute the software and store the output in the memory location rendered and ready to be displayed on an electronic display without any further processing. The system can store other versions of the output in the memory location and display those when the user makes an edit that matches the stored output. For example, if the software generates a circle with a radius of 2 inches and the software has a parameter that can be edited to increase or decrease the radius, the system can render outputs of the circle at other radii and store those in memory. If the user makes an edit to the parameter, such as to increase the radius of the circle, then the system can present the updated output (circle with a larger radius) to the user from memory without having to re-execute the software.

A computer processor can initially execute software to generate an output. In some cases, upon subsequent edits to one or more lines of code of the software, the software may not be re-executed. This enables the output to be dynamically generated and presented to the user in real time or substantially real time. In some situations, however, the software may be re-executed to generate an output.

In some examples, upon the user making an edit to a line of code, the software can be executed or re-executed, such as by using a computer processor. The system can determine whether to execute or re-execute the software if the system determines that the changes made by the user do not have a corresponding output in memory or that the system cannot readily determine the output without having to execute the software.

In some examples, an output is rendered in real time or substantially real time using a visual programming environment. The visual programming environment can include software for writing visualizations, images, and interactive content that can be provided on an electronic display. In some cases, the visual programming environment can allow a user interface to display animations, visual applications, games and other graphical rich content without the need for an applet or plugin.

In an example, the visual programming environment employs JavaScript or other interpreted computer programming language, such as C++, Java or .NET. For instance, in JavaScript, Processing.js may be used to provide a rendered output in a web browser response to code inputted by a user. Processing.js may be employed in a web-based user interface, such as a web browser.

In some cases, code is executed in real time or substantially real time. The code in some cases can be re-run and dynamically injected into the run time. This provides the user with the ability to change variables, colors, or functions during runtime without restarting a program and executing (or re-executing) the software.

An individual line of code can be executed individually and an output can be generated or updated based on the individual line of code. As an alternative, a group of code (e.g., multiple lines of code) can be executed at the same time, and the output can be generated or updated upon execution of the group of code. As another alternative, software can be executed in its entirety, and the output can be generated or updated upon execution of the software.

### User Interfaces for Displaying Computer Code and Outputs

Another aspect of the present disclosure provides user interfaces for displaying computer code and the corresponding output upon execution. A user interface can be a graphical user interface or a web-based user interface (e.g., web browser). The user interface can be provided on an electronic device of a user (e.g., instructor, student). The electronic device can be in communication with a system (e.g., server) that is programmed or otherwise configured to enable the user to view computer code, edit the computer code, and view output(s) associated with the computer code.

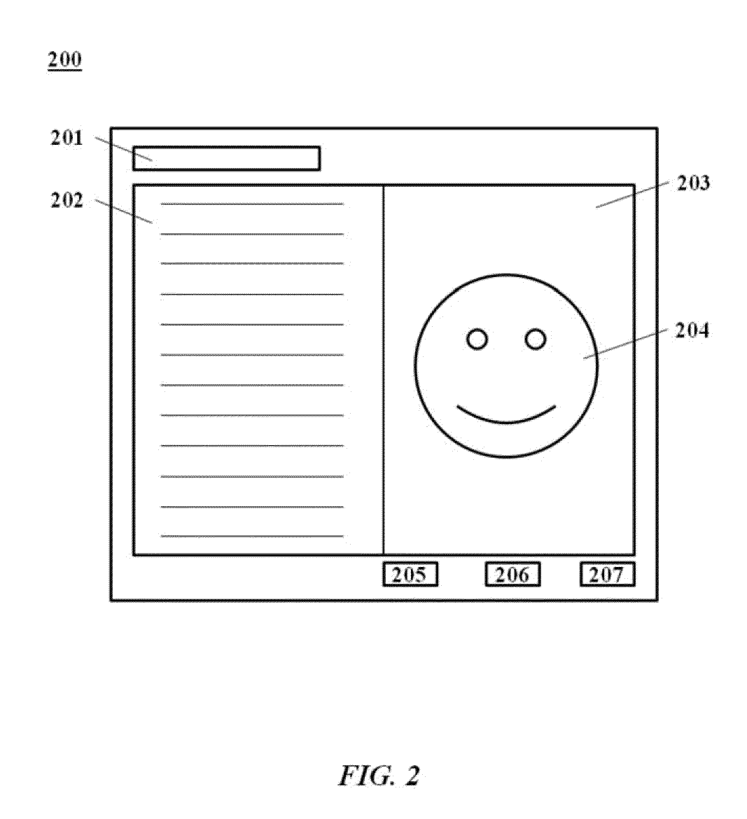

FIG. 2 shows a user interface 200. The user interface 200 can be a graphical user interface or a web-based user interface. The user interface 200 includes a title field 201 (e.g., “Hello world program”), a code editor 202, and an output field 203 that displays a graphical output 204 (smiley face in the illustrated example). A user can use the code editor 202 to input computer code and make changes to the code. The user can input a title in the title field 201. The user interface 200 also includes a save button 205 that enables the user to save a given program, including the code in the code editor 202 and the corresponding output 204. The code can be saved for view and use by other users (see below). A restart button 206 permits the user to restart the software (e.g., re-execute the code in the code editor 202). A share button 207 enables the user to share a link to the code user interface 200 with other users, such as users in social network sites (e.g., Facebook®, Google+®, Twitter®, Tumblr®) or users by electronic mail (“email”).

A user can create and/or edit one or more lines of code, view the corresponding output, and save the one or more lines of code (saved code) in a data repository, such as a memory location, for future use by the user or other users of the system. In some cases, the output associated with the one or more lines of code can also be saved. For example, a first user can input lines of code that output a red circle when executed by a computer processor of the system. The first user can save the one or more lines of code and, in some cases, the output, for future use by a second user. The first user can grant the first user access rights to view and/or edit the saved code, or the first user can make the saved code accessible by all users of the system. As an alternative, the first user can make the saved code private, in which case the saved code is not viewable by other users.

Code can be saved in one or more data repositories of the system, such as a memory location (or memory) or other electronic data storage unit. In some cases, one or more outputs associated with the code can be stored in a data repository of the system.

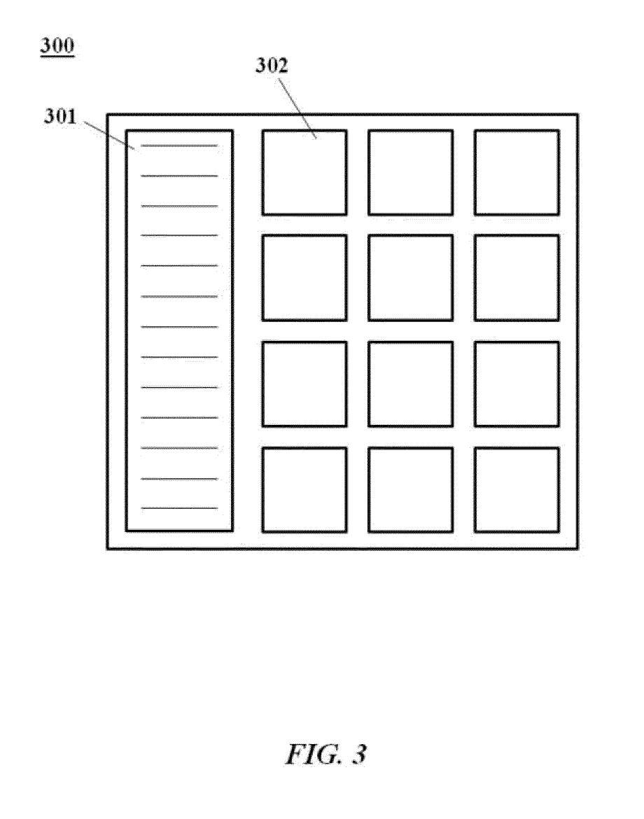

Saved code can be presented to a user in a user interface that can display textual and/or graphical information corresponding to the saved code. The user interface can include a plurality of saved code which may be created by various users. FIG. 3 shows a user interface 300 that includes a menu field 301 with menu items corresponding to categories of saved code (e.g., “Calculus,” “Drawing,” “Games”). The user interface 300 can be a graphical user interface or a web-based user interface. The user interface 300 includes graphical elements 302 corresponding to the saved code. Each of the graphical elements 302 can include identifying information (e.g., name and/or avatar) of the user that saved the saved code associated with the graphical element, a rating of the saved code (e.g., “558 votes”), and the number of times the saved code was used as a starting point to generate derivative works (or “Spin-offs”). The number of spin-offs can serve as an indication of the usefulness of the saved code to other users.

For example, a user can select a given graphical element among the graphical elements 302 to open a code editor and output field (see, e.g., FIG. 2) to view the saved code and the associated output. The user can edit the code (e.g., change the colors of various elements of the output associated with the code), provide a title selected by the user, and save the edited code. The user can select a graphical element to associate with the new saved code, such as, for example, a screenshot of the output associated with the code. As an alternative, the system can select a graphical element, such as, for example, a screenshot of the output associated with the code. The screenshot can be sized as appropriate. The system can then include the graphical element in the user interface 300, which can enable other users to view the user's saved code and output.

The output(s) associated with saved code is generated upon execution of the saved code by a user. As an alternative, the output(s) can be saved along with the saved code, and when a user accesses the saved code to view the code, the output(s) can be presented to the user without executing the saved code. In such a case, the output(s) may correspond to a state of the saved code that was last executed by the user or another user.

### Responsive Playback and Tutorials

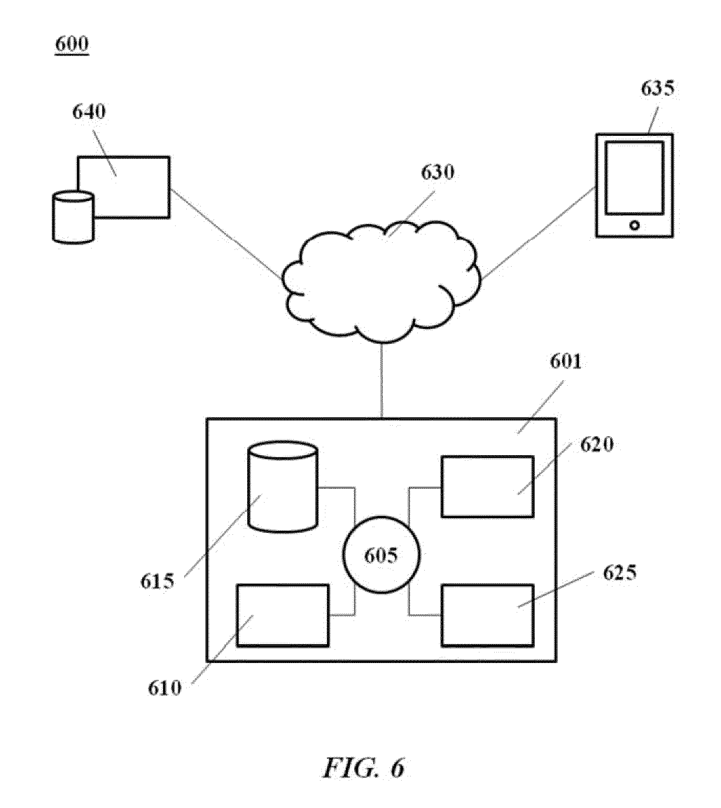

Another aspect of the present disclosure provides a responsive coding environment that provides a recorded coding session. The recorded coding session can include one or more lines of code inputted with time, instructions that accompany with one or more lines of code with time, and the output generated with time. The recorded session can be played back by other users as part of a tutorial. This can enable users to follow along what was typed or otherwise inputted and what changed in the output as the code progressed with time. For example, a first user (instructor) can prepare a recorded session in which the first user discusses a given computer programming topic, such as FOR loops, and inputs lines of code as part of an example. The lines of code generate an output upon execution of the code. The lines of code inputted by the user, associated output(s) and voice of the user are recorded as a function of time for later playback by a second user (e.g., student). Recorded coding sessions can be implemented by a computer system, such as the system 601 of FIG. 6.

A recorded session can be stored in one or more data repositories of the system, such as a memory location (or memory) or other electronic data storage unit. Users can access a data repository to view a recorded session.

In some examples, every keystroke or lines of code is saved while recording a coding session along with instructions, which can be conveyed by the voice of a user providing the instructions. For example, a programming teacher can type code and provide voice instructions as the user types the code. The typed code and voice instructions can be recorded.

In some cases, the output can change with time as the code is updated. As an alternative, however, the output does not change with time. Output that is dynamically generated during the coding session can also be recorded. The coding session, which can include the inputted code and the corresponding output with time, can be recorded and stored in memory for later playback. Such instructional material can be accessed by other users, such as students, for playback.

The playback can be provided on an electronic display of a user, such as a student. The user can start the playback and see inputted code and the corresponding output with time, as well as corresponding instructions (e.g., audible and/or visual instructions), with time. The user can interrupt the playback at any time to edit or otherwise revise the code, such as a given parameter or line of code. The system can update the output to in view of edits or other changes made by the user, in some cases without having to execute or re-execute the code. However, in some situations, the system may execute or re-execute the code based on edits or other changes made by the user.

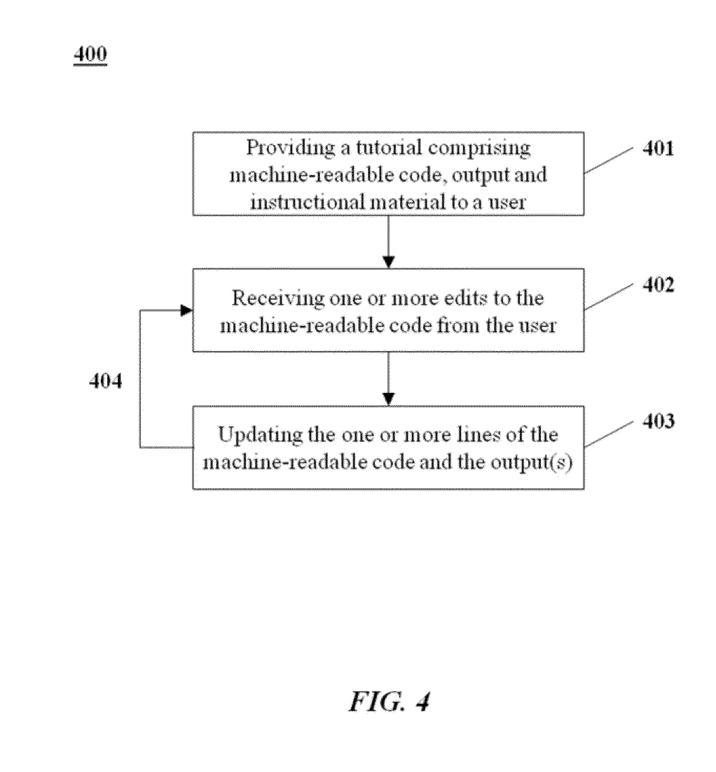

FIG. 4 shows a method 400 for providing computer programming instructions. The method can be implemented by a computer system, such as the system 601 of FIG. 6. The method 400 comprises, in a first operation 401, providing, on an electronic device of a user, a tutorial comprising one or more lines of machine-readable code, output associated with the machine-readable code, and instructional material associated with the one or more lines of machine-readable code. In a second operation 402, one or more edits to the one or more lines of machine-readable code can be received from the user. An edit can include, without limitation, the addition of new code, changes to existing code, or the deletion of existing code. Next, in a third operation 403, the one or more lines of machine-readable code and the output can be updated based on the one or more edits. In some cases, the output can updated without re-executing the software.

The instructional material can include textual, video and/or audio information presented on the electronic device, such as on an electronic display or with the aid or speakers of the electronic device.

In some cases, the second 402 and third operations 403 can be repeated 404 based on subsequent edits from the user. As an alternative, the second 402 and third operations 403 can be repeated 404 upon request from the user. For example, the user may wish to have the output regenerated, and can request to have the one or more lines of machine-executable code processed to regenerate the output. The second 402 and third operations 403 can be repeated subsequent to receiving an edit from the user. For example, the second 402 and third operations 403 can be executed from 1-100 times.

The one or more lines of machine-readable code can be provided to the user sequentially, such as, for example, at least about 0.000001 seconds, 0.00001 seconds, 0.0001 seconds, 0.001 seconds, 0.01 seconds, 0.1 seconds, 1 second, 2 seconds, 3 seconds, 4 seconds, 5 seconds, 10 seconds, 20 seconds, 30 seconds, 40 seconds, 50 seconds, 1 minute, 2 minutes, 3 minutes, 4 minutes, 5 minutes or more of one another. The instructional material can be provided to the user as the one or more lines of machine-readable code are sequentially provided to the user. For example, the instructional material can indicated that a FOR loop is changed to a WHILE loop, and the machine-readable code is updated simultaneously or substantially simultaneously to reflect this change. Any changes to the output can be presented on the electronic device.

A given segment of the instructional material can correspond to a given segment or version of the machine-readable code. For instance, a first segment can discuss the code with a FOR loop and a second segment can discuss the code that has been updated to include a WHILE loop. The instructional material can include a segment (e.g., 30 seconds voice recording) that corresponds to each segment of the machine-readable code.

In some situations, the output(s) associated with the machine-readable code are provided in a pre-recorded fashion—i.e., a given output is stored and presented to the user with the corresponding machine-readable code that generates the output. As an alternative, the output(s) can be generated in real time or substantially real time as the machine-readable code is presented to the user. In some cases, at least some of the output can be presented to the user without executing or re-executing the machine-readable code.

The instructional material can be provided by way of a recording, such as a textual, video and/or sound file stored on the electronic device of the user. As an alternative, the instructional material can be provided by the system, such as, for example, via streaming to the electronic device of the user.

The instructional material can be pre-recorded or live. In some examples, a user records instructional material coupled the machine-readable code and the corresponding output, and other users access the recording at a subsequent point in time. As an alternative, the user may provide the instructional material and the machine-readable code, along with the corresponding output, in real time (e.g., in a live instructional or tutorial session).

A tutorial, which can include a playback, can be provided to a user in a user interface that includes a code editor and an output field, such as the interface 200 of FIG. 2. The user interface for playback can further include an integrated video player that progresses through the code and associated output, along with instructions from another user (e.g., instructor), with time.

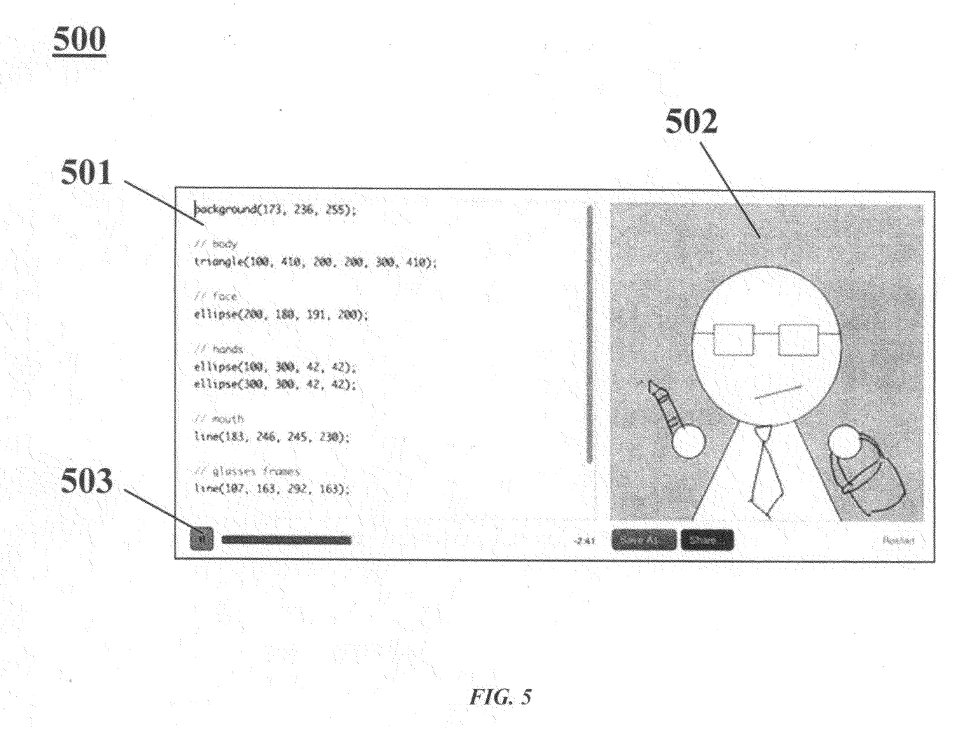

FIG. 5 shows a screenshot of an example tutorial user interface 500 comprising lines of code 501, output 502, and controls 503 of a video player to start, stop (or pause), or restart the tutorial. The user interface 500 can be a graphical user interface or a web-based user interface. The interface 500, including the code 501 and output 502, can change with time as the tutorial progresses from start to finish. There can be a one-to-one correspondence between the code 501 and the output 502 that is dynamically generated as the code 501 changes. This can enable the user to visualize changes to the output 502 upon changes to the code 501. Changes to the output 502 can occur in real time or substantially real time, in some cases without re-executing the code 501.

The user can pause or stop the tutorial and make changes to the code 501. The system can update or otherwise change the output 502 upon changes made to the code 501. This can enable the user to interact with the code 501 during playback. The user can step backwards or forwards in time to other segments of the tutorial to visualize the code 501 and associated output 502. The output at various points can be rendered without re-executing the code 501.

In some cases, a user, such as an instructor, can generate a recorded session. For example, an instructor can explain a computer programming concept by presenting multiple lines of code, and record his or her voice while explaining the code. The system can generate an output to correspond to the multiple lines of code. The recorded session can be stored in one or more data repositories of the system.

### Systems

Another aspect of the disclosure provides a system that is programmed or otherwise configured to implement the methods of the disclosure. The system can include a computer server that is operatively coupled to an electronic device of a user (e.g., student).

FIG. 6 shows a system 600 comprising a computer system or computer server (“server”) 601 that is programmed or otherwise configured to provide computer programming instructions, including outputs of machine-readable instructions. The server 601 includes a central processing unit (CPU, also “processor” and “computer processor” herein) 605, which can be a single core or multi core processor, or a plurality of processors for parallel processing. The server 601 also includes memory or memory location 610 (e.g., random-access memory, read-only memory, flash memory), electronic storage unit 615 (e.g., hard disk), communication interface 620 (e.g., network adapter) for communicating with one or more other systems, and peripheral devices 625, such as cache, other memory, data storage and/or electronic display adapters. The memory 610, storage unit 615, interface 620 and peripheral devices 625 are in communication with the CPU 605 through a communication bus (solid lines), such as a motherboard. The storage unit 615 can be a data storage unit (or data repository) for storing data. The server 601 can be operatively coupled to a computer network (“network”) 630 with the aid of the communication interface 620. The network 630 can be the Internet, an internet and/or extranet, or an intranet and/or extranet that is in communication with the Internet. The network 630 in some cases is a telecommunication and/or data network. The network 630 can include one or more computer servers, which can enable distributed computing, such as cloud computing. The network 630, in some cases with the aid of the server 601, can implement a peer-to-peer network, which may enable devices coupled to the server 601 to behave as a client or a server.

The CPU 605 can execute a sequence of machine-readable instructions, which can be embodied in a program or software. The instructions may be stored in a memory location, such as the memory 610. Examples of operations performed by the CPU 605 can include fetch, decode, execute, and writeback.

The storage unit 615 can store files, such as drivers, libraries and saved programs. The storage unit 615 can store programs generated by users and recorded sessions, as well as output(s) associated with the programs. The storage unit 615 can store user data, e.g., user preferences and user programs. The server 601 in some cases can include one or more additional data storage units that are external to the server 601, such as located on a remote server that is in communication with the server 601 through an intranet or the Internet.

The server 601 can communicate with one or more remote computer systems through the network 630. In the illustrated example, the server 601 is in communication with a first computer system 635 and a second computer system 640 that are located remotely with respect to the server 601. The first computer system 635 can be the computer system of user, such as a student, and the second computer system 640 can be an external data repository. The first computer system 635 can be, for example, personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the server 601 via the network 630 to view computer code and output(s).

The system 600 can include a single server 601 or multiple servers in communication with one another through an intranet and/or the Internet. In some examples, the system 600 includes multiple servers 601 coupled to one another through an intranet.

The server 601 can be adapted to store user profile information, such as, for example, a name, physical address, email address, telephone number, instant messaging (IM) handle, educational information, work information, social likes and/or dislikes and historical information (e.g., that may relate to the progress of a user in achieving an objective), and other information of potential relevance to a student and/or teacher. Such profile information can be stored on the storage unit 615 of the server 601.

Methods as described herein can be implemented by way of machine (e.g., computer processor) executable code stored on an electronic storage location of the server 601, such as, for example, on the memory 610 or electronic storage unit 615. The machine executable or machine readable code can be provided in the form of software. During use, the code can be executed by the processor 605. In some cases, the code can be retrieved from the storage unit 615 and stored on the memory 610 for ready access by the processor 605. In some situations, the electronic storage unit 615 can be precluded, and machine-executable instructions are stored on memory 610. Alternatively, the code can be executed on the second computer system 640.

The code can be pre-compiled and configured for use with a machine have a processor adapted to execute the code, or can be compiled during runtime. The code can be supplied in a programming language that can be selected to enable the code to execute in a pre-compiled or as-compiled fashion.

Aspects of the systems and methods provided herein, such as the server 601, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The server 601 can be configured for data mining, extract, transform and load (ETL), or spidering (including Web Spidering where the system retrieves data from remote systems over a network and access an Application Programming Interface or parses the resulting markup) operations, which may permit the system to load information from a raw data source (or mined data) into a data warehouse. The data warehouse may be configured for use with a business intelligence system (e.g., Microstrategy®, Business Objects®). The system can include a data mining module adapted to search for media items in various source locations, such as email accounts and various network sources, such as social networking accounts (e.g., Facebook®, Foursquare®, Google+®, Linkedin®) or on publisher sites, such as, for example, weblogs.

Computer software can include computer programs, such as, for example, executable files, libraries and scripts. Software can include defined instructions that upon execution instruct computer hardware (e.g., an electronic display) to perform various tasks, such as display graphical elements on an electronic display. Software can be stored in computer memory.

Software can include machine-executable code. Machine-executable code can include machine language instructions specific to an individual computer processor, such as a CUP. Machine language can include groups of binary values signifying processor instructions that change the state of an electronic device (e.g., a computer) from its preceding state. For example, an instruction can change the value stored in a particular storage location inside the computer. An instruction may also cause an output to be presented to a user, such as graphical elements to appear on an electronic display of a computer system. The processor can carry out the instructions in the order they are provided.

Software comprising one or more lines of code and their output(s) can be presented to a user on a user interface (UI) of an electronic device of the user. Examples of UI's include, without limitation, a graphical user interface (GUI) and web-based user interface. A GUI can enable a user to access the software to view the one or more lines of code, and an output associated with all or a subset of the one or more lines of code. The GUI can enable the user to edit the one or more lines of code, such as an individual line. The UI (e.g., GUI) can be provided on a display of an electronic device of the user. The display can be a capacitive or resistive touch display, or a head-mountable display (e.g., Google® Glasses). Such displays can be used with other systems and methods of the disclosure.

Methods of the disclosure can be facilitated with the aid of applications (apps) that can be installed on electronic devices of a user. An app can include a GUI on a display of the electronic device of the user. The app can be programmed or otherwise configured to perform various functions of the system.

### Example 1

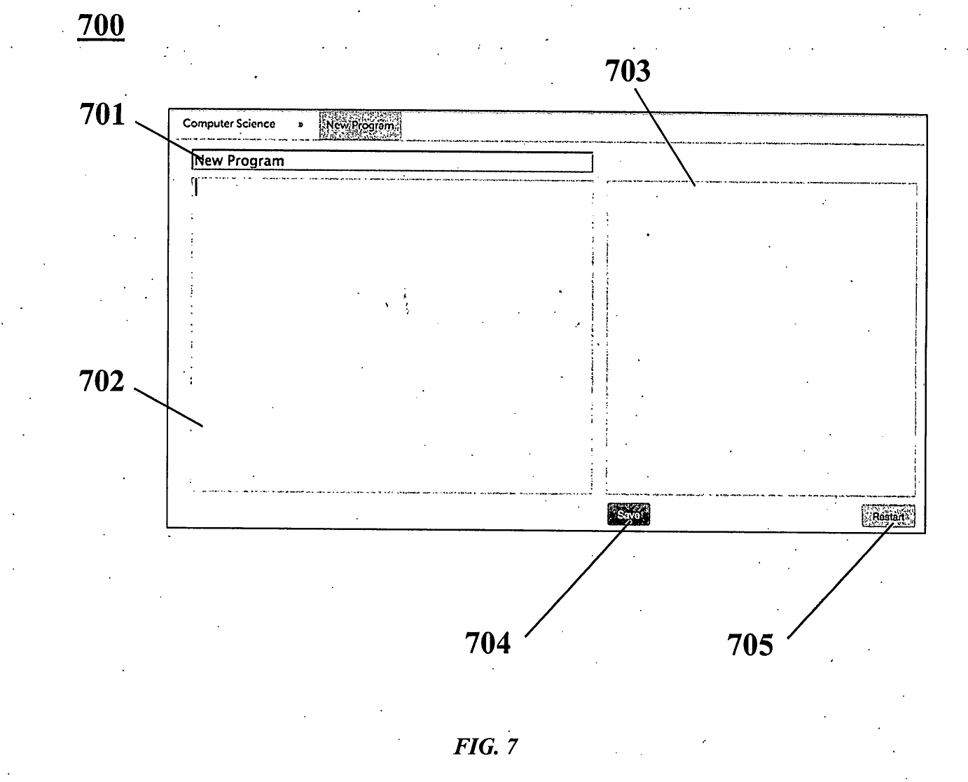

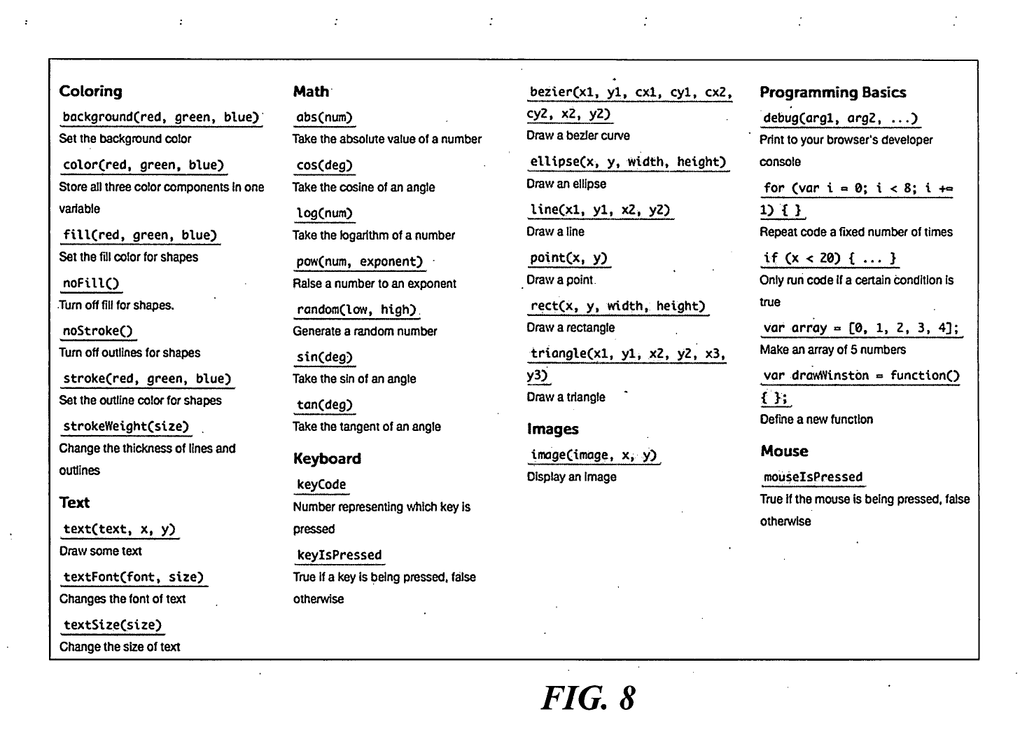

FIG. 7 shows a screenshot of a user interface 700 for generating a new program. The user interface includes a title input field 701, code editor 702, output field 703, save button 704 and program restart button 705. A user can input code in the code editor 702 and dynamically visualize the output in the output field 703. The program restart button 705 enables the user to re-execute the program. In the code editor 702, the user can input code selected by the user and compatible with the code editor 702 (e.g., code that is compatible with a compiler associated with the code editor 702). In some examples, the user can input code with functions selected from FIG. 8.

### Example 2

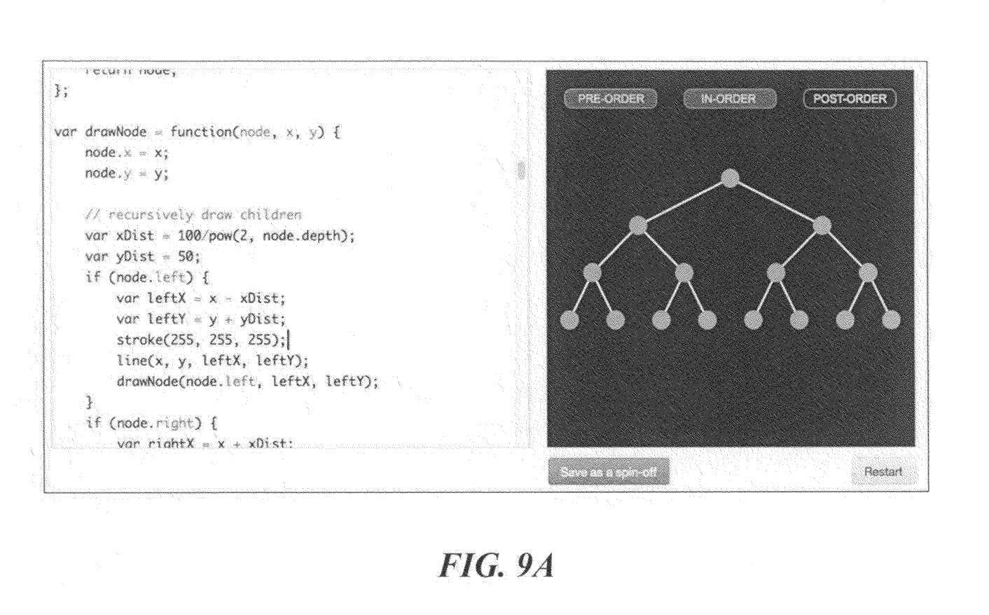

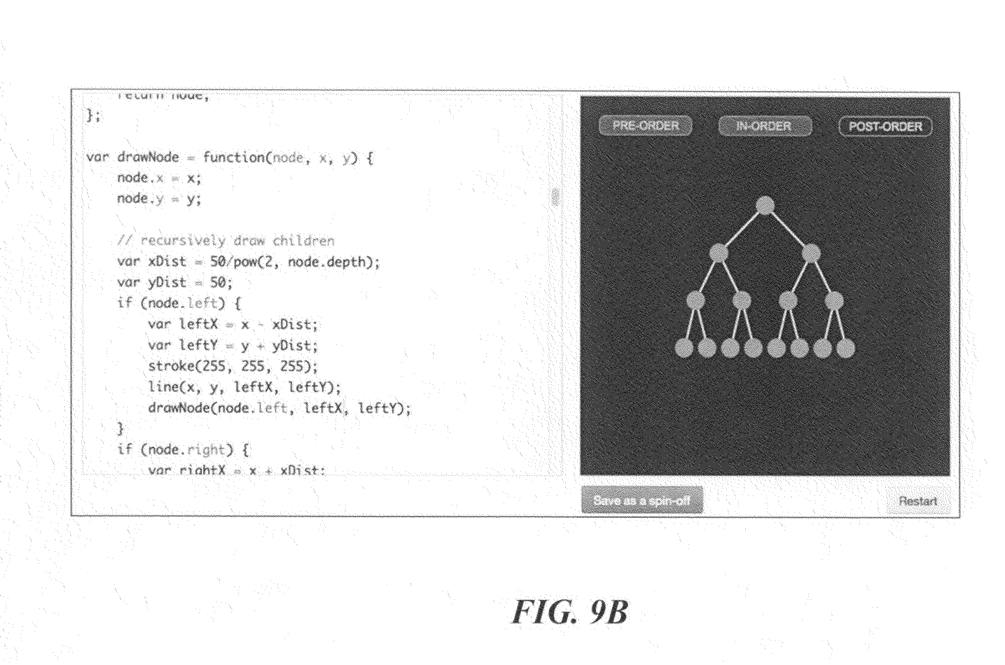

FIGS. 9A and 9B are screenshots of an example program output (right panel) that is dynamically generated based on changes to code (left panel). In FIG. 9A, the variable xDist is equal to 100, and in FIG. 9B, this variable is changed to 50. The result is that the width of the corresponding output is dynamically decreased by a factor of two. The changes in the output occur without re-executing the code.

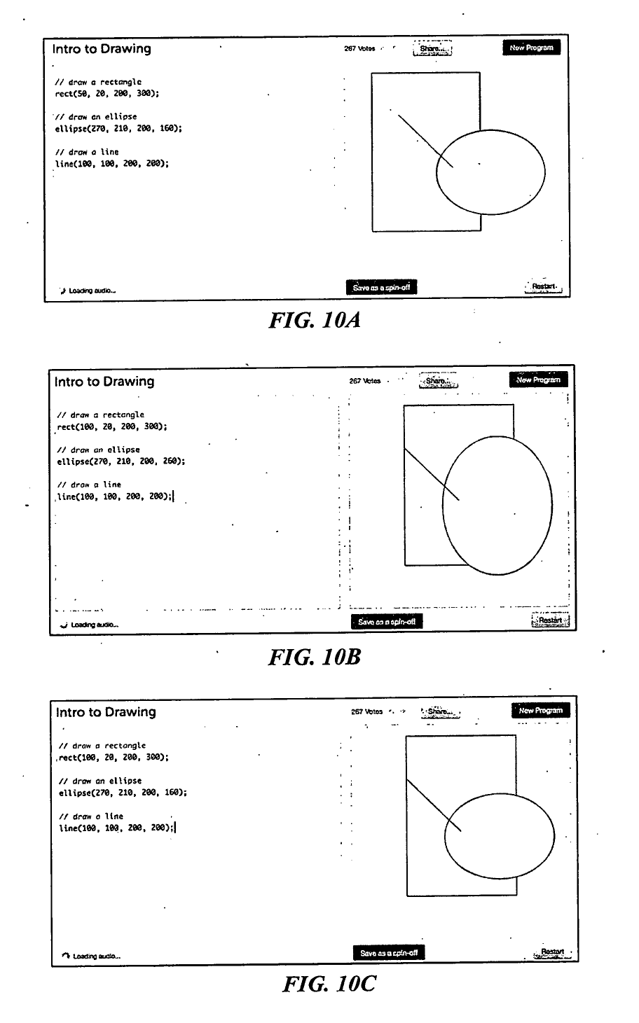

FIGS. 10A-10C are screenshots of another example of output that is dynamically updated with changes in computer code. The screenshots illustrate a user interface comprising a code editor with machine-readable code (left panel) and the associated output (right panel). The output includes a rectangle, line and ellipse. From FIG. 10A to 10B, the position of the rectangle is dynamically changed by editing the variable rect( ) From FIG. 10B to 10C, the shape of the ellipse is changed by editing the variable ellipse( ) The user interface enables a user to save each version of the code and its associated output as a spin-off (or derivative work) for use by the user or other users.

### Example 3

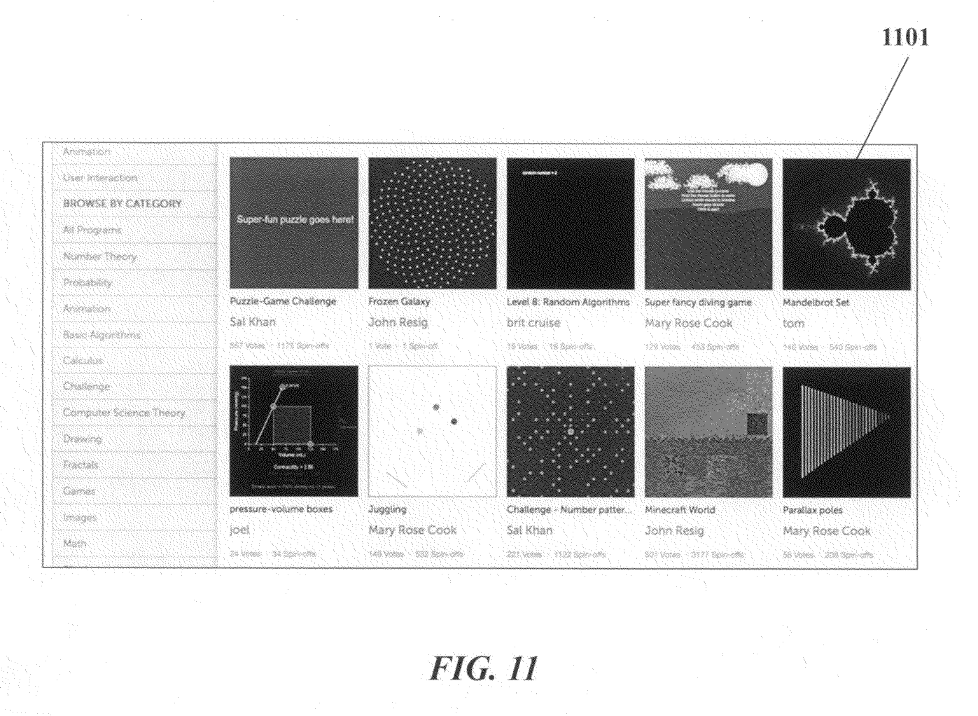

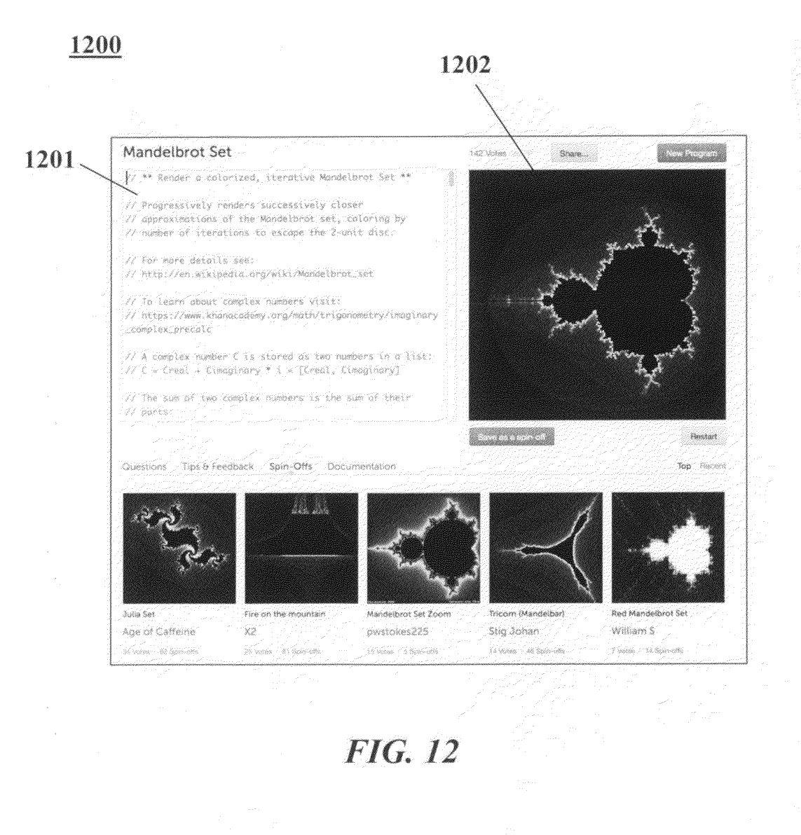

FIG. 11 is a screenshot of a user interface showing community programs created by various users. A community program can be accessed by clicking on a graphical element associated with the community program. For example, a user can click on the “Mandelbrot Set” program 1101 to display a user interface 1200 comprising a code editor panel 1201 and output panel 1202, as shown in FIG. 12. The code editor panel 1201 includes machine-executable code that generates output(s) in the output panel 1202. FIG. 12 also shows other programs (bottom) that are derivative works of the Mendelbrot Set program.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents. It is intended that the following claims define the scope of the invention and that methods and structures within the scope of these claims and their equivalents be covered thereby.

What is claimed is:

1. A computer-implemented method for providing output(s) of machine readable instructions, comprising:
(a) providing software comprising one or more lines of machine-readable instructions, wherein said one or more lines are associated with an output upon execution by a computer processor, wherein said output comprises at least one visual and/or audible component;
(b) executing said software using said computer processor to generate said output;
(c) simultaneously displaying said one or more lines of machine-readable instructions and said output on an electronic display of a user;
(d) receiving from said user one or more edits to said one or more lines of machine-readable instructions; and
(e) updating said one or more lines of machine-readable instructions and said output based on said one or more edits, wherein said output is updated without re-executing said software.

2. The method of claim 1, wherein said software is provided in a memory location coupled to said computer processor.

3. The method of claim 1, wherein said output is stored in a memory location in a rendered state.

4. The method of claim 1, wherein said one or more edits include an addition or deletion from said one or more lines of machine-readable instructions.

5. The method of claim 1, wherein said electronic display comprises a user interface, and wherein said one or more lines of machine-readable instructions and said output are displayed in said user interface.

6. The method of claim 5, wherein said user interface is a web-based user interface.

7. The method of claim 1, wherein said electronic display and said computer processor are part of an electronic device of said user.

8. The method of claim 1, wherein said software comprises a plurality of lines of machine-readable instructions and said output corresponds to at least a subset of said plurality of lines.

9. The method of claim 8, wherein (c) further comprises sequentially displaying individual lines of said plurality of lines and a corresponding output on said electronic display.

10. A computer-implemented method for providing computer programming instructions, comprising:
(a) providing, on an electronic device of a user, a tutorial comprising (i) software having one or more lines of machine-readable code, (ii) an output associated with said machine-readable code, and (iii) instructional material associated with at least a subset of said one or more lines of machine-readable code;
(b) receiving one or more edits to said one or more lines of machine-readable code from said user on said electronic device; and
(c) updating said one or more lines of machine-readable code and said output based on said one or more edits.

11. The method of claim 10, wherein said instructional material is provided on said electronic device as said one or more lines of machine-readable code are sequentially provided to said user.

12. The method of claim 10, wherein providing said tutorial comprises executing said software by a computer processor to generate said output.

13. The method of claim 12, wherein said output is updated without re-executing said software.

14. The method of claim 10, wherein providing said tutorial comprises providing said one or more lines of machine-readable code, said output and said instructional material on a user interface of said electronic device.

15. The method of claim 14, wherein said user interface is a web-based user interface.

16. A system for providing output(s) of machine readable instructions, comprising:
an electronic display comprising a user interface having at least a first panel and a second panel adjacent to said first panel, wherein said first panel displays software comprising one or more lines of machine-readable instructions and said second panel displays an output associated with said one or more lines of machine-readable instructions; and
a computer processor coupled to said electronic display and programmed to (i) execute said software comprising said one or more lines of machine-readable instructions to generate said output, (ii) simultaneously display said one or more lines of machine-readable instructions in said first panel and said output in said second panel, (iii) receive one or more edits to said one or more lines of machine-readable instructions from a user, and (iv) update said one or more lines of machine-readable instructions in said first panel and said output in said second panel based on said one or more edits, wherein said output is updated without re-executing said software.

17. The system of claim 16, further comprising a memory location having said software, wherein said memory location is coupled to said computer processor.

18. The system of claim 16, further comprising a memory location that stores said output in a rendered state.

19. The system of claim 16, wherein said software comprises a plurality of lines of machine-readable instructions and said output corresponds to at least a subset of said plurality of lines, and wherein said computer processor is programmed to sequentially display individual lines of said plurality of lines in said first panel and a corresponding output in said second panel.

20. The system of claim 16, wherein said user interface is a web-based user interface.
